(19) United States
(12) Patent Application Publication
(10) Pub. No.: US 2022/0347974 A1
(43) Pub. Date: Nov. 3, 2022

(54) LAMINATED GLASS FOR VEHICLE

(71) Applicant: AGC Inc., Tokyo (JP)

(72) Inventors: Shunsuke SADAKANE, Tokyo (JP); Ryota OKUDA, Tokyo (JP); Makoto FUKAWA, Tokyo (JP); Minami HAGIWARA, Tokyo (JP)

(73) Assignee: AGC Inc., Tokyo (JP)

(21) Appl. No.: 17/835,704

(22) Filed: Jun. 8, 2022

Related U.S. Application Data
(63) Continuation of application No. PCT/JP2020/046895, filed on Dec. 16, 2020.

(30) Foreign Application Priority Data
Dec. 20, 2019 (JP) 2019-230102

(51) Int. Cl. B32B 17/10; B32B 3/10; B32B 7/12; B32B 27/08; B32B 7/025

(52) U.S. Cl. CPC B32B 17/10449; B32B 17/10036; B32B 3/10; B32B 7/12; B32B 27/08; B32B 7/025; B32B 2250/02; B32B 2250/03; B32B 2250/40; B32B 2307/212; B32B 2307/542; B32B 2307/732; B32B 2605/006

(57) ABSTRACT

The present invention relates to a laminated glass for vehicle, including a first glass plate and a second glass plate joined to each other by an intermediate film, in which the first glass plate has a second main surface facing the intermediate film; the laminated glass has a first region with the second glass plate and a second region with no second glass plate in a plan view; the laminated glass has a filling portion that includes an electromagnetic wave transmission member and is disposed continuously from the second main surface on the second region toward a space between the first glass plate and the second glass plate in the first region to cross the entire boundary between the first region and the second region; and the second region is higher in transmittance of millimeter waves than the first region.

### CROSS-REFERENCE TO RELATED APPLICATIONS

This is a continuation of International Application No. PCT/JP2020/046895 filed on Dec. 16, 2020, and claims priority from Japanese Patent Application No. 2019-230102 filed on Dec. 20, 2019, the entire content of which is incorporated herein by reference.

### TECHNICAL FIELD

The present invention relates to a laminated glass for vehicle.

### BACKGROUND ART

In recent years, high-speed, large-capacity communication infrastructures such as the 4th generation mobile communication system (hereinafter abbreviated as 4G) long term evolution (LTE) and the 5th generation mobile communication system (hereinafter abbreviated as 5G) in addition to communication systems using the microwave and millimeter wave wavelength bands have been being expanding. And bands used for these purposes are tend to expand from a 3 GHz band to a 5-100 GHz band.

In the case where electromagnetic waves are transmitted to and received from a system existing outside a vehicle by using, for example, a millimeter-wave radar installed inside the vehicle to perform a communication in such a high frequency band, there occurs gain attenuation by a window glass which was not remarkable in communications performed so far in relatively low frequency bands. To accommodate this problem, a structure is known in which an electromagnetic wave transmission member is buried in part of a window glass to obtain a large gain in a system for transmitting or receiving electromagnetic waves between apparatus located inside and outside the vehicle through the window glass by using a millimeter-wave radar (refer to Patent Document 1).

In particular, Patent Document 1 discloses window members having various structures for increasing the transmittance of electromagnetic waves emitted from a millimeter-wave radar. For example, Patent document 1 discloses a window member that is in such a form that an electromagnetic wave transmission member is provide in a space obtained by removing a part of one glass plate and a part of an intermediate film of a laminated glass having two glass plates and the intermediate film interposed therebetween.

Patent document 1: WO 2017/188415

### SUMMARY OF INVENTION

However, in the window member disclosed in Patent document 1, in the case of containing an electromagnetic wave transmission member, the strength may lower at the boundary between an ordinary laminated glass portion and the portion having the electromagnetic wave transmission member in a plan view of the glass. Patent document 1 does not disclose a specific configuration capable of suppressing such strength reduction.

In view of the above, an object of the present invention is to provide a laminated glass for vehicle, having a more specific configuration that can suppress strength reduction at a boundary between different materials in a plan view and is excellent in the transmittance of prescribed electromagnetic waves of, for example, a millimeter-wave radar.

A laminated glass for vehicle, according to the present invention for attaining the above object is a laminated glass for vehicle, including a first glass plate and a second glass plate joined to each other by an intermediate film, in which the first glass plate has a first main surface and a second main surface; the second glass plate has a third main surface and a fourth main surface; the second main surface and the third main surface face the intermediate film; the laminated glass for vehicle has a first region A that is provided with the second glass plate and a second region B that is not provided with the second glass plate in a plan view of the first glass plate; the laminated glass for vehicle includes a filling portion that is disposed continuously from the second main surface on the second region B toward a space between the first glass plate and the second glass plate in the first region A to cross the entire boundary between the first region A and the second region B; the filling portion includes an electromagnetic wave transmission member; and the second region B is higher in transmittance of millimeter waves than the first region A.

Another laminated glass for vehicle, according to the present invention for attaining the above object is a laminated glass for vehicle, including a first glass plate and a second glass plate joined to each other by an intermediate film, in which the first glass plate has a first main surface and a second main surface; the second glass plate has a third main surface and a fourth main surface; the second main surface and the third main surface face the intermediate film; the laminated glass for vehicle has a first region A that is provided with the second glass plate and a second region B that is not provided with the second glass plate in a plan view of the first glass plate; the intermediate film is disposed continuously so as to overlap with the entire second region B in a plan view of the first glass plate and to cross the entire boundary between the first region A and the second region B; the laminated glass for vehicle includes a filling portion only above the second main surface in the second region; the filling portion includes an electromagnetic wave transmission member and an adhesive layer that is disposed on a surface, facing the second main surface, of the electromagnetic wave transmission member; in the second region B, the first glass plate, the intermediate film, the adhesive layer, and the electromagnetic wave transmission member are stacked in this order; and the second region B is higher in transmittance of millimeter waves than the first region A.

Another laminated glass for vehicle, according to the present invention for attaining the above object is a laminated glass for vehicle, including a first glass plate and a second glass plate joined to each other by an intermediate film, in which the first glass plate has a first main surface and a second main surface; the second glass plate has a third main surface and a fourth main surface; the second main surface and the third main surface face the intermediate film; the laminated glass for vehicle has a first region A that is provided with the second glass plate and a second region B that is not provided with the second glass plate in a plan view of the first glass plate; the laminated glass for vehicle includes a filling portion only on the second main surface in the second region; the filling portion includes an electromagnetic wave transmission member; the electromagnetic wave transmission member is adjacent to the second main surface, an inside end surface of the intermediate film, and an inside end surface of the second glass plate, and includes at least one layer of a urethane resin layer; and the second region B is higher in transmittance of millimeter waves than the first region A.

The laminated glass for vehicle according to the present invention can suppress strength reduction at a boundary between different materials in a plan view and is excellent in the transmittance of prescribed electromagnetic waves of a millimeter-wave radar or the like.

### BRIEF DESCRIPTION OF DRAWINGS

FIG. 1A is an exploded perspective view illustrating a configuration of a laminated glass for vehicle according to a first embodiment.

FIG. 1B is a perspective view illustrating an opening portion of a second glass plate of the laminated glass for vehicle according to the first embodiment.

FIG. 1C is a perspective view illustrating a cut portion of another second glass plate of the laminated glass for vehicle according to the first embodiment.

FIG. 2 is a plan view of a first glass plate of the laminated glass for vehicle according to the first embodiment.

FIG. 3 is a cross-sectional view of a laminated glass for vehicle according to the first embodiment.

FIG. 4 is a cross-sectional view of a laminated glass for vehicle according to a first modification of the first embodiment.

FIG. 5 is a cross-sectional view of a laminated glass for vehicle according to a second modification of the first embodiment.

FIG. 6 is a cross-sectional view of a laminated glass for vehicle according to a third modification of the first embodiment.

FIG. 7 is a cross-sectional view of a laminated glass for vehicle according to a fourth modification of the first embodiment.

FIG. 8 is a cross-sectional view of a laminated glass for vehicle according to a fifth modification of the first embodiment.

FIG. 9 is a cross-sectional view of a laminated glass for vehicle according to a second embodiment.

FIG. 10 is a cross-sectional view of a laminated glass for vehicle according to a third embodiment.

FIG. 11 is a cross-sectional view of a laminated glass for vehicle according to a fourth embodiment.

FIG. 12 is a conceptual diagram illustrating a state that a laminated glass for vehicle according to the present invention is attached to a front opening portion formed on an automobile.

FIG. 13 is an enlarged view of a portion S illustrated in FIG. 12.

FIG. 14 is a graph showing a simulation result of transmittance T(F) at a frequency F (GHz) of electromagnetic waves incident at an incident angle of 67.5° on a laminated glass for vehicle of each of Inventive Examples and a Comparative Example.

### DESCRIPTION OF EMBODIMENTS

Although embodiments of the present invention will be hereinafter described in detail, embodiments of the present invention are not restricted to the ones described below. Members or portions that exhibit the same action may be described by giving the same symbol to them in drawings, and duplicated descriptions therefor may be omitted or simplified. Each embodiment is illustrated in drawings in a schematic manner to describe the present invention clearly and does not necessarily reflect sizes and scales in an actual product correctly.

Laminated glasses having a configuration that an intermediate film made of a resin, for example, is held between or bonded to plural glass plates are low in the degree of scattering of glass fragments when broken by external impact and hence is high in safety. Therefore, such laminated glasses have been broadly used conventionally as window glasses and the like of vehicles such as automobiles and trains, airplanes, buildings, and the like.

In particular, a laminated glass for vehicle is required to satisfy a prescribed impact resistance and penetration resistance that are prescribed in the JIS Standard R3211: 2015 (Safety glazing materials for road vehicles). The impact resistance test method and the penetration resistance method using a steel ball having a prescribed mass are prescribed in the JIS Standard R3212: 2015 (Test methods of safety glazing materials for road vehicles). In this specification, the impact resistance test and the penetration resistance test are also referred to as “falling ball tests” together.

For example, the impact resistance test is a test for checking whether a safety glass such as a laminated glass for vehicle has adhesion or strength that is necessary to resist impact produced by a small and hard flying object. More specifically, this test is carried out by keeping a laminated glass (safety glass) at a prescribed temperature, setting the glass on a support frame with its surface to be located on the outside of a vehicle up, and causing a steel ball to make a free fall from a prescribed height.

The penetration resistance test is a test for checking whether a glass to be used as a windshield has necessary penetration resistance. More specifically, this test is carried out by keeping a laminated glass (safety glass) at a prescribed temperature, setting the glass on a support frame with its surface to be located on the inside of a vehicle up, and causing a steel ball to make a free fall from a prescribed height.

The laminated glass for vehicle according to the present is excellent in the transmittance of electromagnetic waves of millimeter-wave radars or the like with an assumption that it satisfies the prescribed falling ball test standards. Specific configurations of the laminated glass will be described below.

### First Embodiment

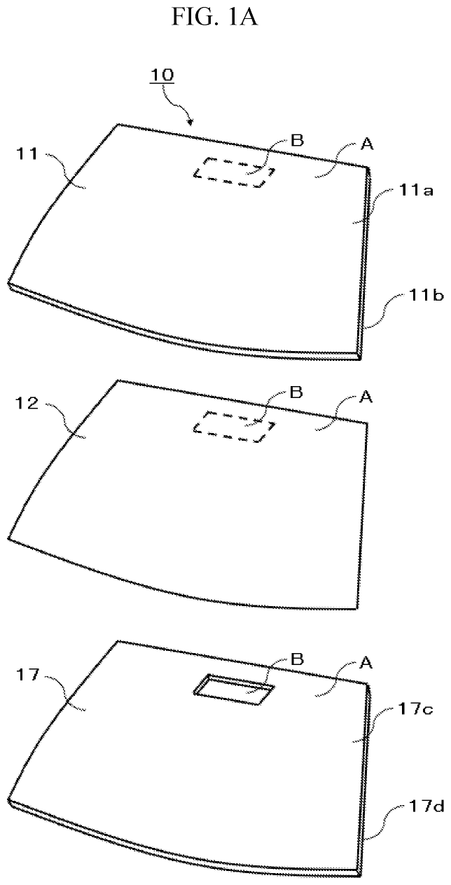

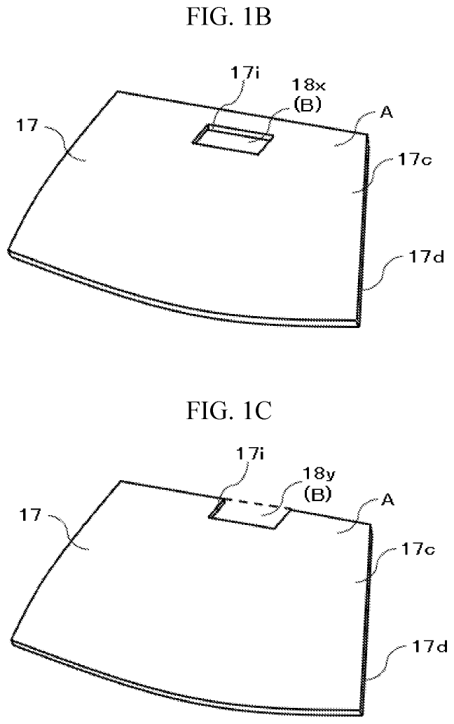

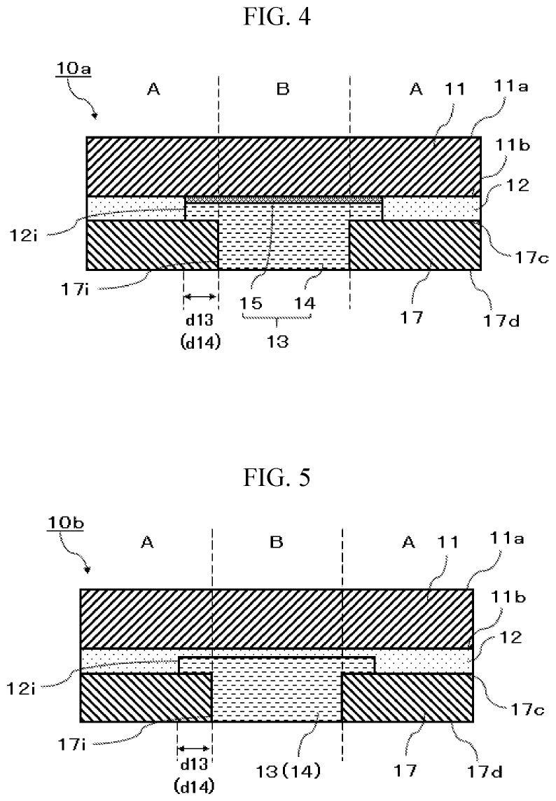

A laminated glass for vehicle according to a first embodiment of the present invention will be described with reference to FIG. 1A to FIG. 8. Laminated glasses for vehicle according to modifications of the first embodiment of the present invention will be described with reference to FIG. 4 to FIG. 8 among these drawings.

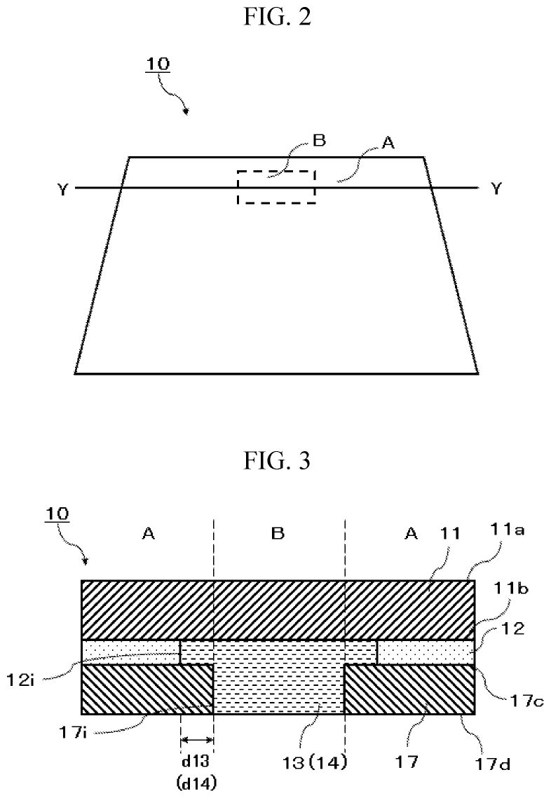

FIG. 1A is an exploded perspective view illustrating the configuration of a laminated glass for vehicle according to this embodiment. FIG. 1B and FIG. 1C are perspective views of respective second glass plates 17 of the laminated glass 10 for vehicle according to this embodiment. FIG. 2 is a plan view of a first glass plate 11 of the laminated glass 10 for vehicle according to this embodiment. The term “laminated glass” means a laminated body having two or more glass plates that are adhered to each other by means of an intermediate film.

Although the laminated glass for vehicle according to this embodiment will be described below as having a basic configuration consisting of two glass plates and one intermediate film interposed therebetween unless otherwise specified, it may include plural intermediate films. The “plan view of the first glass plate 11” means a view, as viewed from above in the vertical direction when the laminated glass for vehicle is placed on a horizontal plane with its first glass plate 11 up.

As illustrated in FIG. 1A, the laminated glass 10 for vehicle according to this embodiment is a laminated body including the first glass plate 11, the intermediate film 12, the second glass plate 17, and a filling portion 13 (described later). Although the laminated glass 10 for vehicle is in many cases curved so as to conform to the body of a vehicle, it may have a shape that is suitable for a use such as a non-curved shape, that is, a flat shape.

As seen from a plan view of the first glass plate 11, the laminated glass 10 for vehicle has a first region Ain which the second glass plate 17 exists and a second region B in which no part of the second glass plate 17 exists. Unless otherwise specified, the laminated glass 10 for vehicle will be described below as a configuration that it is oriented so that the first glass plate 11 is located on the vehicle outside and the second glass plate 17 is located on the vehicle inside when attached to a vehicle body.

The second region B is formed in a region, where high transmittance is required with respect to electromagnetic waves in a frequency range of 60 GHz to 100 GHz, of the laminated glass 10 for vehicle. For example, the second region B is formed in a peripheral region including a portion through which electromagnetic waves of millimeter-wave radar are to be transmitted and received. In this specification, evaluation (e.g., high or low) of electromagnetic wave transmittance is for the electromagnetic wave transmittance with respect to electromagnetic waves in the frequency range of 60 GHz to 100 GHz unless otherwise specified.

Although the laminated glass 10 for vehicle has the one approximately rectangular second region B in a plan view of the first glass plate 11, the shape (an outer circumference in a plan view) and the number of the second region B are not limited to those of this configuration. For example, they are determined as appropriate so as to be, for example, polygonal (e.g., triangular, rectangular, or trapezoidal), or circular in a plan view of the first glass plate 11 taking into consideration positions of a millimeter-wave radar, a stereo camera, or the like which are provided inside the vehicle rather than the second glass plate 17.

In order to allow an information device to detect electromagnetic waves in a millimeter-wave band, the area of the second region B of the laminated glass 10 for vehicle is preferably 400 mm² or larger and even preferably 1,000 mm² or larger in a plan view. Furthermore, in order to enable transmission and reception of electromagnetic waves (signals) in millimeter waves by plural information devices through it, the area of one second region B is further preferably 4,000 mm² or larger and particularly preferably 10,000 mm² or larger. The area of the second region B is preferably 90,000 mm² or smaller so that excessive deformation does not occur even when an external force acts on a central portion of the second region B.

It is preferable that the second region B be located outside the “test region A” that is prescribed in the attachment “The test region for the optical characteristics and the light resistance of a safety glass” to the JIS Standard R3212: 2015 (Test methods of safety glazing materials for road vehicles) because in that case the boundary between the first region A and the second region B are located outside a field of view of a driver. In large-size vehicles, it is preferable that the second region B be located outside the “test region I” because in that case the boundary between the first region A and the second region B are located outside a field of view of a driver.

To secure necessary strength, in particular, to increase the chipping resistance for flying rock, the thickness of the first glass plate 11 is preferably 1.1 mm or larger, even preferably 1.5 mm or larger, and further preferably 1.8 mm or larger. Although there are no particular limitations on the upper limit of the thickness of the first glass plate 11, usually the thickness of the first glass plate 11 is preferably 3.0 mm or smaller because the weight increases with the thickness.

As illustrated in FIG. 1A, in the laminated glass 10 for vehicle according to the embodiment, the first glass plate 11 has a first main surface 11 a and a second main surface llb and the intermediate film 12 is adjacent to the second main surface 11b. Likewise, the second glass plate 17 has a third main surface 17c and a fourth main surface 17d and the intermediate film 12 is adjacent to the third main surface 17c. The second glass plate 17 has, as its portion, an opening portion that overlaps with the second region B. Alternatively, the second glass plate 17 may have, as its portion, a cut portion that overlaps with the second region B.

The opening portion of the second glass plate 17 will be described with reference to FIG. 1B. The opening portion 18x corresponds to the second region B in the case where no part of the outer circumference of the first glass plate 11 is in contact with the second region B in a plan view of the first glass plate 11 of the laminated glass 10 for vehicle.

Next, the cut portion of the second glass plate 17 will be described with reference to FIG. 1C. The cut portion 18y corresponds to the second region B in the case where a part of the outer circumference of the first glass plate 11 is adjacent to the second region B in a plan view of the first glass plate 11 of the laminated glass 10 for vehicle.

For example, in the second glass plate 17 illustrated in FIG. 1C, the part of the outer circumference of the first glass plate 11 is drawn by a broken line. That is, in the laminated glass 10 for vehicle having the second glass plate 17 illustrated in FIG. 1C, the outer circumference of the cut portion (second region B) is approximately rectangular in a plan view of the first glass plate 11 and one side of the approximate rectangle is adjacent (common) to the part of the outer circumference of the first glass plate 11.

The second glass plate 17 of the laminated glass 10 for vehicle including the cut portion and/or the opening portion may be approximately the same in shape as the first glass plate 11 in a plan view of the first glass plate 11. In the following description, of the end surfaces of the intermediate film 12 or the second glass plate 17 of the laminated glass 10 for vehicle, the end surface common to the outer circumference of the second region B in a plan view of the first glass plate 11 will also be referred to as an “inside end surface.” Of the end surfaces of the intermediate film 12 or the second glass plate 17, the end surface other than the inside end surface will also be referred to as an “outside end surface.”

The laminated glass 10 for vehicle is higher in strength at the boundary between the first region A and the second region B in the case where the second region B is the opening portion as compared to the case where the second region B is the cut portion. This is because in the case where the second region B is the opening portion, the entire region outside the opening portion is the first region A and hence impact in the ball falling tests can be dispersed easily.

In the case where the second region B is the opening portion, it suffices that the distance from the end portion of the first glass plate 11 to the opening portion (second region B) in a plan view of the first glass plate 11 be 10 mm or longer, preferably 30 mm or longer and even preferably 50 mm or longer. On the other hand, if the distance from the end portion of the first glass plate 11 to the opening portion (second region B) is too long, the field of view may be unduly narrow. Thus, it suffices that the distance from the end portion of the first glass plate 11 to the opening portion (second region B) be 200 mm or shorter.

From the viewpoint of the ease of handling, the thickness of the second glass plate 17 is preferably 0.3 mm or larger, even preferably 0.5 mm or larger, and further preferably 1.0 mm or larger. From the viewpoint of lightweight, the thickness of the second glass plate 17 is preferably 2.3 mm or smaller and even preferably 2.0 mm or smaller. The first glass plate 11 and the second glass plate 17 may be either the same as or different from each other in composition and thickness.

The first glass plate 11 and the second glass plate 17 are shaped into a plate shape by a float method, for example, and then bent and formed at a high temperature by gravity forming, press forming, or the like. Each of the first glass plate 11 and the second glass plate 17 may be either a non-strengthened glass plate or a strengthened glass plate. A strengthen glass plate may be either a physically strengthened glass plate or a chemically strengthened glass plate.

There are no particular limitations on the composition of the first glass plate 11 and the second glass plate 17 in this embodiment. Examples thereof include a composition in which the content of each component in mol % in terms of oxides satisfies:

50%≤SiO₂≤80%;

0.1%≤Al₂O₃≤25%;

3%≤R₂O≤30% (R₂O is the total content of Li₂O, Na₂O, and K₂O);

0%≤B₂O₃≤10%;

0%≤MgO≤25%;

0% CaO≤25%;

0%≤SrO≤5%;

0%≤BaO≤5%;

0%≤ZrO₂≤5%; and

0%≤SnO₂≤5%.

A glass plate that can be used as an electromagnetic wave transmission member (exemplified later as an electromagnetic wave transmission member) may be used as the first glass plate 11 and/or the second glass plate 17.

The intermediate film 12 adheres the first glass plate 11 and the second glass plate 17 to each other. The intermediate film 12 may be in contact with at least a part of the second main surface 11b of the first glass plate 11 and at least a part of the third main surface 17c of the second glass plate 17. The intermediate film 12 may be in contact with the entire second main surface 11b and the entire third main surface 17c.

In this embodiment, as the intermediate film 12, use can be made of an intermediate film that is generally employed in laminated glasses, and examples thereof include a thermoplastic resin, a thermosetting resin, and an ultraviolet setting resin. The intermediate film 12 can be formed by solidifying any of these resins. The term “solidifying” as used therein includes “curing”.

For the intermediate film 12, use can be preferably made of a resin containing at least one kind selected from the group consisting of vinyl polymers, copolymers of ethylene/vinyl monomers, styrene copolymers, polyurethane resins, fluororesins, silicone resins, and acryl resins.

The intermediate film 12 may be made of a resin that is in liquid form before heating. Typical usable examples of thermoplastic resins include polyvinyl butyral, ethylene vinyl acetate, cycloolefin polymers, and the like. Typical examples of thermosetting resins include silicone resins and acryl resins. The intermediate film 12 may be formed by using either one or a combination of these examples.

Alternatively, for the intermediate film 12, an adhesive that is used for an adhesive layer (described later) may be used. In the case where the intermediate film 12 is made of an adhesive, it is not necessary to perform heating in joining the first glass plate 11 and the second glass plate 17 to each other and hence there is no probability of occurrence of cracking or bending as mentioned above. The thickness of the intermediate film 12 may be 0.1 mm or larger and 2 mm or smaller.

Next, the laminated glass for vehicle according to this embodiment will be described further with reference to FIG. 3 to FIG. 8. Each of FIG. 3 to FIG. 8 is a cross-sectional view, taken along line Y-Y, of the laminated glass 10 for vehicle illustrated in FIG. 2, and illustrates a cross section including the first region A and the second region B.

First, the configuration illustrated in the cross-sectional view of FIG. 3 of the laminated glass 10 for vehicle will be described. The laminated glass 10 for vehicle has a filling portion 13. In this embodiment, the filling portion 13 is formed by only an electromagnetic wave transmission member 14 (described later).

The structure of the filling portion 13 will be described below with reference to FIG. 3. In this embodiment, the filling portion 13 illustrated in FIG. 3 has a surface that faces the second main surface 11b. The filling portion 13 is adjacent to a part of the second main surface 11b and a part of the third main surface 17c and is fully side by side with an inside end surface 12i of the intermediate film 12 and an inside end surface 17i of the second glass plate 17. The expression “side by side with” is different from “adjacent to” and includes the case where a gap exists between the surfaces concerned.

The filling portion 13 may be adjacent to all or a part of the inside end surface 17i of the second glass plate 17. In this case, friction occurs more likely between the filling portion 13 and the second glass plate 17 than in the case where the filling portion 13 is not in contact with the inside end surface 17i of the second glass plate 17. As a result, the durability of the boundary between the first region A and the second region B as tested by the falling ball tests can be increased, whereby the strength of the laminated glass 10 for vehicle can be increased. In the case where the filling portion 13 adheres to the second glass plate 17, the strength of the boundary between the filling portion 13 and the inside end surface 17i of the second glass plate 17 can be increased further.

In the case where the filling portion 13 is adjacent to or side by side with the entire inside end surface 17i of the second glass plate 17 and forms approximately the same plane with the fourth main surface 17d, no step is formed between the second glass plate 17 and the filling portion 13 and the boundary between the different materials is not conspicuous spatially particularly when viewed from inside the vehicle, which is preferable.

The filling portion 13 is disposed continuously from the second main surface 11b on the second region B of the laminated glass 10 for vehicle toward a space between the first glass plate 11 and the second glass plate 17 in the first region A to cross the entire boundary between the first region A and the second region B. Owing to this configuration, the filling portion 13 can absorb impact and serve as a stopper for preventing dislocation at the boundary between the inside end surface 17i of the second glass plate 17 and the filling portion 13 when an external force is applied from, for example, a steel ball to the first main surface 11 a in the impact resistance test for the laminated glass 10 for vehicle. Thus, strength reduction at the boundary between first region A and the second region B can be suppressed.

Furthermore, in the laminated glass 10 for vehicle according to this embodiment, for example, in the penetration resistance test, dislocation at the boundary between the inside end surface 17i of the second glass plate 17 and the filling portion 13 and dislocation at the boundary between the inside end surface 12i of the intermediate film 12 and the filling portion 13 located between the second main surface 11b and the third main surface 17c can be prevented from coupling with each other. As a result, in the laminated glass 10 for vehicle, strength reduction at the boundary between the first region A and the second region B can be suppressed.

Next, a distance d13 (d14) is defined as the distance between the boundary between the first region A and the second region B and the circumference of the filling portion 13 (electromagnetic wave transmission member 14) in the first region Ain a plan view of the first glass plate 11. In the case where the distance d13 (d14) is short, when an external force acts on the first main surface 11a, the member (electromagnetic wave transmission member 14) filled in the filling portion 13 may disengage from the laminated glass 10 for vehicle to cause penetration of a steel ball. In order to prevent disengagement of the electromagnetic wave transmission member 14 and suppress strength reduction at the boundary between the different materials, the distance d13 is preferably 0.1 mm or longer, even preferably 1 mm or longer, and further preferably 5 mm or longer.

On the other hand, the distance d13 is preferably 30 mm or shorter because in that case the boundary between the inside end surface 12i of the intermediate film 12 and the filling portion 13 can be hidden easily by a light shield portion (described later). The distance d13 is even preferably 15 mm or shorter.

In the case where another (i.e., second) second region B exists that is spaced from the second region B, for example, another filling portion that is different from the filling portion 13 may be disposed continuously between the first glass plate 11 and the second glass plate 17 so as to cross the entire boundary between the first region A and the second second region B in a plan view of the first glass plate 11. Alternatively, the filling portion 13 may be disposed continuously between the first glass plate 11 and the second glass plate 17 so as to cross the entire boundary between the first region A and the second second region B. In this case, the number of boundaries between different materials and between the same materials can be reduced.

In the laminated glass 10 for vehicle according to this embodiment, the filling portion 13 may overlap with either all of the second region B or a part of the second region B in a plan view of the first glass plate 11. The filling portion 13 overlapping with the entire second region B in a plan view of the first glass plate 11 is preferable because in that case the number of boundaries between different materials in the second region B is made smaller and hence strength reduction can be suppressed.

In the second region B of the laminated glass 10 for vehicle according to this embodiment, for example, an electromagnetic wave transmission member 14 that is higher in millimeter-wave transmittance than the second glass plate 17 having the above-described glass composition can be disposed in place of the second glass plate 17. In this case, the second region B can be made higher in millimeter-wave transmittance than the first region A.

The electromagnetic wave transmission member 14 will be described below. There are no particular limitations on the material of the electromagnetic wave transmission member 14 as long as it can enhance the transmittance of prescribed millimeter waves with a frequency of 60 GHz or higher. It can be used preferably a member made of a material that is low in permittivity and small in tans (dielectric loss tangent; 8 is a loss angle) and, in particular, small in dielectric loss. Examples of the material constituting the electromagnetic wave transmission member 14 include glass materials and resins.

There are no particular limitations on the kind of resin. Examples of usable resins include ABS (acrylonitrile butadiene styrenes), PVC (polyvinyl chlorides), fluororesins, PC (polycarbonates), COP (cycloolefin polymers), SPS (syndiotactic polystyrene resins), modified PPE (modified polyphenylene ethers), urethane resin, PS (polystyrenes), and PET (polyethylene terephthalates).

Examples usable glass materials constituting the electromagnetic wave transmission member 14 include alkali-free glass. Alkali-free glass is glass in which the total content of alkali components in mol % in terms of oxides is 1.0% or lower. Alkali-free glass containing alkali components at 0.1% or lower in total can also be used preferably. Although there are no particular limitations on the contents of the other components, it is preferable that, for example, the content of each component in mol % in terms of oxides satisfies:

50%≤SiO₂≤80%;

0%≤Al₂O₃≤30%;

0%≤B₂O₃≤25%;

0%≤MgO≤25%;

0%≤CaO≤25%;

0%≤SrO≤25%;

0%≤BaO≤25%;

0%≤ZrO₂≤5%; and

5%≤RO≤40% (RO is the total content of MgO, CaO, SrO, and BaO).

The above-described kinds of glass and resins may be used either singly or in combination to constitute the electromagnetic wave transmission member 14.

In the case where the difference in the linear expansion coefficient between the first glass plate 11 and the electromagnetic wave transmission member 14 is large, the laminated glass 10 for vehicle may crack or warp to cause an appearance failure in the case where a heating process is executed to join the first glass plate 11 and the second glass plate 17 to each other. It is therefore preferable that the difference between the linear expansion coefficient of the first glass plate 11 and that of the electromagnetic wave transmission member 14 be as small as possible.

The difference in the linear expansion coefficient between the first glass plate 11 and the electromagnetic wave transmission member 14 may be expressed in the form of the difference between their average linear expansion coefficients in a prescribed temperature range. In the case where the electromagnetic wave transmission member 14 is made of a resin material, since in particular the resin material is lower in glass transition temperature than the glass material, a prescribed average linear expansion coefficient difference may be set in a temperature range that is lower than or equal to the glass transition temperature of the resin material. Alternatively, a difference between the linear expansion coefficient of the first glass plate 11 and that of the resin material may be set at a prescribed temperature that is lower than or equal to the glass transition temperature of the resin material.

### First Modification

FIG. 4 is a cross-sectional view of a first modification (laminated glass 10a for vehicle) of the laminated glass 10 for vehicle, and illustrates a cross section taken at the same position as line Y-Y for the laminated glass 10 for vehicle illustrated in FIG. 2. In this modification, features that are different from the laminated glass 10 for vehicle according to the first embodiment will be described, and for the other features, corresponding descriptions made for the laminated glass 10 for vehicle according to the first embodiment will be employed.

The laminated glass 10a for vehicle according to the first modification is different from the first embodiment in that the filling portion 13 has an adhesive layer 15 in addition to the electromagnetic wave transmission member 14.

In the laminated glass 10a for vehicle illustrated in FIG. 4, the adhesive layer 15 is adjacent to the entire surface, facing the second main surface 11b, of the electromagnetic wave transmission member 14 and at least a part of the second main surface 11b of the first glass plate 11.

The adhesive layer 15 may be adjacent to a part of the surface, facing the second main surface 11b, of the electromagnetic wave transmission member 14. Although each of the electromagnetic wave transmission member 14 and the adhesive layer 15 is adjacent to a part of the inside end surface 12i of the intermediate film 12 in FIG. 4, it may be side by side with a part of the inside end surface 12i of the intermediate film 12. In the first region A, the sum of the thickness of the electromagnetic wave transmission member 14 and the thickness of the adhesive layer 15 coincides with the thickness of the intermediate film 12.

In the laminated glass 10a for vehicle, the electromagnetic wave transmission member 14 and the adhesive layer 15 are disposed continuously from the second main surface l lb on the second region B toward a space between the first glass plate 11 and the second glass plate 17 in the first region A to cross the entire boundary between the first region A and the second region B. And the electromagnetic wave transmission member 14 and the adhesive layer 15 overlap with the entire second region B in a plan view of the first glass plate 11.

Alternatively, either one of the electromagnetic wave transmission member 14 and the adhesive layer 15 may be disposed continuously so as to overlap with the entire second region B in a plan view of the first glass plate 11 and, from the second main surface 11b on the second region B toward a space between the first glass plate 11 and the second glass plate 17 in the first region A, to cross the entire boundary between the first region A and the second region B. In this case, in the first region A, corresponding one of the thickness of the electromagnetic wave transmission member 14 and the thickness of the adhesive layer 15 coincides with the thickness of the intermediate film 12.

The adhesive layer 15 will be described below in detail. The adhesive layer 15 exerts an effect of causing strong joining between the glass plate, the intermediate film, the electromagnetic wave transmission member, and the like. In this modification, the adhesive layer 15 bonds the first glass plate 11 and the electromagnetic wave transmission member 14 to each other. Thus, when an external force acts on the first main surface 11a, an event can be prevented that the electromagnetic wave transmission member 14 disengages from the laminated glass 10a for vehicle to cause penetration of a steel ball. In particular, the adhesive layer 15 is highly effective in such a case where the adhesion of the electromagnetic wave transmission member 14 to the first glass plate 11 is weak or a case where the electromagnetic wave transmission member 14 exhibits no adhesion.

Furthermore, since the laminated glass 10a for vehicle has the adhesive layer 15, the positions of the members can be fixed before the intermediate film 12 and the members other than the adhesive layer 15 are joined to each other by heating. For example, since the adhesive layer 15 exists, an event can be prevented that the position of the electromagnetic wave transmission member 14 moves to cause an unintended gap between (at the boundary of) the inside end surface 12i of the intermediate film 12 and the electromagnetic wave transmission member 14 or between (at the boundary of) the inside end surface 17i of the second glass plate 17 and the electromagnetic wave transmission member 14. Thus, generation of air bubbles or strength reduction at these boundaries can be prevented.

The laminated glass 10a for vehicle may include, separately from the adhesive layer 15, another adhesive layer (not illustrated) for bonding the electromagnetic wave transmission member 14 and the second glass plate 17 to each other. This adhesive layer may be formed of either the same kind as or a different kind than the above-described adhesive layer 15 for bonding the first glass plate 11 and the electromagnetic wave transmission member 14. The kind and the properties of the adhesive layer can be determined as appropriate depending on the bonding target members.

The adhesive layer 15 can be obtained by curing a curable composition such as a photocurable resin composition, a thermosetting resin composition, and a photocurable and thermosetting resin composition. The term “photocurable resin composition” means a resin composition that can be cured by exposure to light. The term “thermosetting resin composition” means a resin composition that can be cured by heating. The term “photocurable and thermosetting resin composition” means a resin composition that can be cured by exposure to light or heating. “Exposure to light” means irradiation with light such as ultraviolet light.

Among curable compositions, photocurable resin compositions are preferable in that they can be cured at a low temperature and are high in curing rate. Since a photocurable resin composition is flowable before being cured, the photocurable resin composition allows plural members such as the first glass plate 11 and the electromagnetic wave transmission member 14 to closely contact to each other easily and can prevent increase of the haze ratio at their interface.

The adhesive layer 15 preferably has a storage shearing modulus being in a range of 5×10² Pa to 1×10⁷ Pa and even preferably 1×10³ Pa to 1×10⁶ Pa at 25° C. and a frequency of 1 Hz.

The shape of the adhesive layer 15 can be maintained easily in the case where its storage shearing modulus is 5×10² Pa or larger. The storage shearing modulus of the adhesive layer 15 being 5×10² Pa or larger is preferable because in that case the electromagnetic wave transmission member 14 can be fixed to such a member as the glass plate or the intermediate film with sufficient strength when sticking via the adhesive layer 15 and the adhesive layer 15 is not prone to be deformed due to, for example, pressure of sticking.

On the other hand, the storage shearing modulus of the adhesive layer 15 being 1×10⁷ Pa or smaller is preferable because in that case even if air bubbles are generated at the interface when the electromagnetic wave transmission member 14 is stuck via the adhesive layer 15, the air bubbles disappear in a short time and hardly remain.

The thickness of the adhesive layer 15 is preferably 0.01 mm or larger and 1.5 mm or smaller. In the case where the thickness of the adhesive layer 15 is 0.01 mm or larger, the adhesive layer 15 can effectively buffer an impact or the like from an external force applied from the first main surface 11a and suppress concentration of the external force on the boundary portion. Furthermore, the thickness of the adhesive layer 15 does not vary to a large extent even if a foreign mater that is smaller than the thickness of the adhesive layer 15 is mixed when the electromagnetic wave transmission member 14 is stuck via the adhesive layer 15.

In the case where the thickness of the adhesive layer 15 is 0.1 mm or larger, the adhesive layer 15 can further effectively buffer the impact or the like from an external force applied from the first main surface 11a and suppress concentration of the external force on the boundary portion. In the case where the thickness of the adhesive layer 15 is 1.5 mm or smaller, the electromagnetic wave transmission member 14 can be stuck easily via the adhesive layer 15 and the thickness of the entire laminated glass 10a for vehicle does not become unnecessarily thick. The thickness of the adhesive layer 15 being 0.7 mm or smaller is preferable because in that case the millimeter-wave transmission loss due to the adhesive layer 15 can be suppressed. The thickness of the adhesive layer 15 is even preferably 0.4 mm or smaller and further preferably 0.2 mm or smaller.

The photocurable resin composition is preferably of a solventless type because in that case heating for removing a solvent is not necessary. The term “solventless type” means that no solvent is contained or the content of a solvent is 5 mass % or less of the entire mass (100 mass %) of the photocurable resin composition. The term “solvent” means a liquid (volatile diluent) whose boiling temperature is 150° C. or lower. It is most preferable that the photocurable resin composition contains no solvent because in that case a drying process can be omitted and time and energy can be saved.

The curable composition typically contains a curable compound (A) having a curable group and a photopolymerization initiator (B). If necessary, the curable composition may contain an uncurable component other than the photopolymerization initiator (B).

Examples of the uncurable component include an uncurable polymer (C), a chain transfer agent (D), and other additives. Examples of the curable compound (A) include acryl compounds, silicone compounds, urethane-acrylate compounds, and epoxy compounds. Among these compounds, it is preferable that the curable compound (A) be a silicone compound or a urethane-acrylate compound because they make it easier to adjust the storage shearing modulus G′ to 5×10² Pa to 1×10⁷ Pa. It is even preferable that the curable compound (A) be a urethane-acrylate compound because it make it easier to adjust the gel fraction to 1% to 50%.

### Second Modification

FIG. 5 is a cross-sectional view of a second modification (laminated glass 10b for vehicle) of the laminated glass 10 for vehicle, and illustrates a cross section taken at the same position as line Y-Y for the laminated glass 10 for vehicle illustrated in FIG. 2. Also in this modification, features that are different from the laminated glass 10 for vehicle according to the first embodiment will be described, and for the other features, corresponding descriptions made for the laminated glass 10 for vehicle according to the first embodiment will be employed.

The laminated glass 10b for vehicle according to the second modification is different from the laminated glass 10 for vehicle in that the intermediate film 12 is disposed continuously so as to overlap with the entire second region B in a plan view of the first glass plate 11 and to cross the entire boundary between the first region A and the second region B. Owing to this configuration, the intermediate film 12 also plays the above-described role of a stopper for preventing dislocation at the boundary. Thus, strength reduction at the boundary between the first region A and the second region B can be suppressed.

In the laminated glass 10b for vehicle, the filling portion 13 is not adjacent to the second main surface 11b and its entire surface facing the second main surface 11b is adjacent to the intermediate film 12. Furthermore, in the first region A, the filling portion 13 illustrated in FIG. 5 is adjacent to a part of the third main surface 17c and is side by side with the entire inside end surface 12i of the intermediate film 12 at the boundary between the first region A and the second region B.

Thus, dislocation itself at the boundary between the inside end surface 12i of the intermediate film 12 and the filling portion 13 when an external force acts on the first main surface 11a can be prevented. As a result, strength reduction at the boundary between the first region A and the second region B can be suppressed further. The inside end surface 12i of the intermediate film 12 is sometimes formed as a result of an event that the intermediate film 12 and the filling portion 13 fit in each other in a compression-bonding process of the laminated glass.

Strength reduction at the boundary can be suppressed effectively in the case where the thickness of at least one of the filling portion 13 and the intermediate film 12 is 0.05 mm or larger in the portion of the first region A where the filling portion 13 and the intermediate film 12 overlap with each other in a plan view of the first glass plate 11. Strength reduction can be suppressed further effectively in the case where that thickness is 0.1 mm or larger.

That thickness of at least one of the filling portion 13 and the intermediate film 12 in the first region A being 1.6 mm or smaller is preferable for weight reduction of the laminated glass 10b for vehicle because the weight of the filling portion 13 or the intermediate film 12 itself is small. That thickness is even preferably 1 mm or smaller, further preferably 0.8 mm or smaller, and particularly preferably 0.4 mm or smaller.

### Third Modification

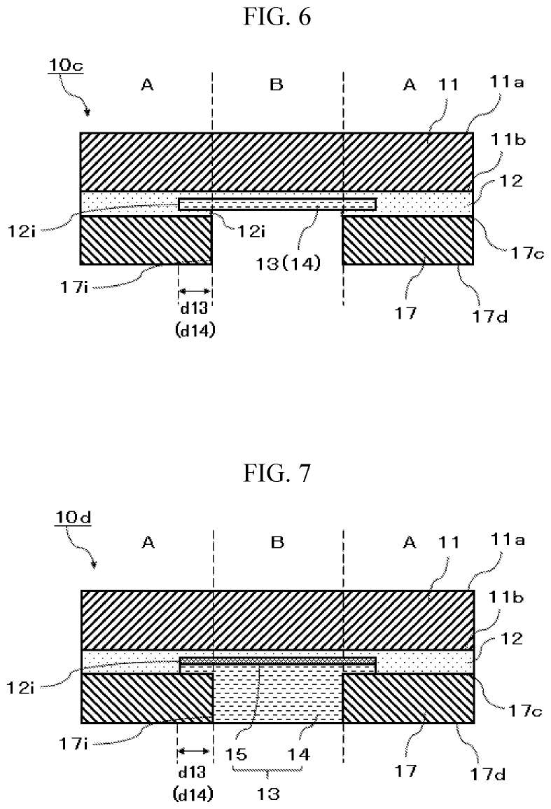

FIG. 6 is a cross-sectional view of a third modification (laminated glass 10c for vehicle) of the laminated glass 10 for vehicle, and illustrates a cross section taken at the same position as line Y-Y for the laminated glass 10 for vehicle illustrated in FIG. 2. In this modification, features that are different from the laminated glass 10b for vehicle according to the second modification of the first embodiment will be described, and for the other features, corresponding descriptions made for the laminated glass 10b for vehicle according to the second modification of the first embodiment will be employed.

In the laminated glass 10c for vehicle, the filling portion 13 is different in that it is not adjacent to any of the second main surface 11b, the third main surface 17c, and the inside end surface 17i of the second glass plate 17, and its entire surface facing the third main surface 17c is adjacent to the intermediate film 12. The filling portion 13 is side by side with a part of the inside end surface 12i of the intermediate film 12 in the first region A.

### Fourth Modification

FIG. 7 is a cross-sectional view of a fourth modification (laminated glass 10d for vehicle) of the laminated glass 10 for vehicle, and illustrates a cross section taken at the same position as line Y-Y for the laminated glass 10 for vehicle illustrated in FIG. 2. In this modification, features that are different from the laminated glass 10a for vehicle according to the first modification of the first embodiment will be described, and for the other features, corresponding descriptions made for the laminated glass 10a for vehicle according to the first modification of the first embodiment will be employed.

The laminated glass 10d for vehicle is different from the laminated glass 10a for vehicle in that in addition to the filling portion 13 including the adhesive layer 15 the intermediate film 12 is disposed continuously so as to overlap with the entire second region B in a plan view of the first glass plate 11 and to cross the entire boundary between the first region A and the second region B. Thus, the filling portion 13 and the intermediate film 12 play the above-described role of the stopper for preventing dislocation at the boundary between the first region A and the second region B.

The adhesive layer 15 is adjacent to the surface, facing the second main surface 11b, of the electromagnetic wave transmission member 14 and bonds the intermediate film 12 and the electromagnetic wave transmission member 14 to each other. In particular, an event that the electromagnetic wave transmission member 14 disengages from the laminated glass 10d for vehicle to cause penetration of a steel ball when an external force acts on the first main surface 11a can be prevented more effectively even in such a case where the adhesion of the electromagnetic wave transmission member 14 to the intermediate film 12 is weak or a case where the electromagnetic wave transmission member 14 exhibits no adhesion. Furthermore, an adhesive failure between the intermediate film 12 and the electromagnetic wave transmission member 14 can be prevented and the haze ratio is improved to a large extent.

In the first region A, the sum of the thickness of the electromagnetic wave transmission member 14 and the thickness of the adhesive layer 15 is smaller than the thickness of the portion, not overlapping with the filling portion 13, of the intermediate film 12. To keep its shape, it is preferable that the thickness of the electromagnetic wave transmission member 14 in the first region A be 0.05 mm or larger. To suppress strength reduction sufficiently at the boundary between the first region A and the second region B, it is even preferable that the thickness of the electromagnetic wave transmission member 14 in the first region A be 0.1 mm or larger.

The thickness of the electromagnetic wave transmission member 14 in the first region A is preferably 1.9 mm or smaller, even preferably 1 mm or smaller, further preferably 0.8 mm or smaller, and particularly preferably 0.4 mm or smaller.

### Fifth Modification

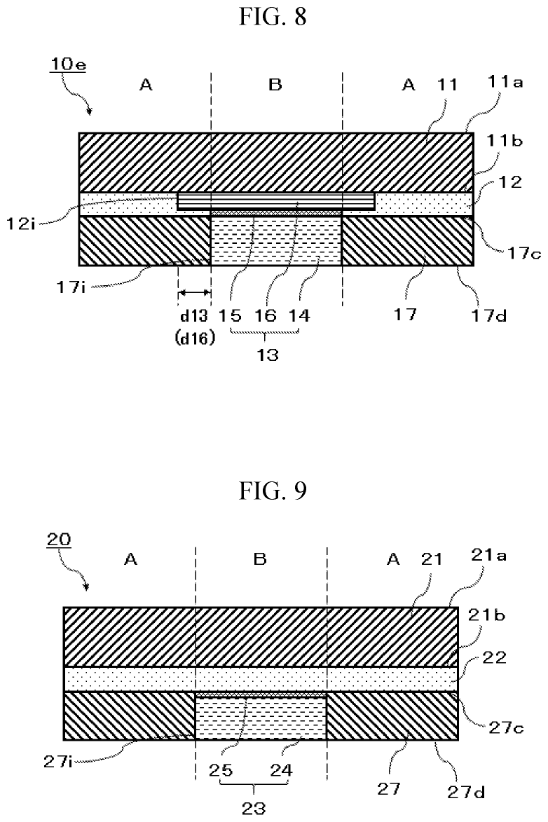

FIG. 8 is a cross-sectional view of a fifth modification (laminated glass 10e for vehicle) of the laminated glass 10 for vehicle, and illustrates a cross section taken at the same position as line Y-Y for the laminated glass 10 for vehicle illustrated in FIG. 2. In this modification, features that are different from the laminated glass 10a for vehicle according to the first modification of the first embodiment will be described, and for the other features, corresponding descriptions made for the laminated glass 10a for vehicle according to the first modification of the first embodiment will be employed.

The laminated glass 10e for vehicle is different from the laminated glass 10a for vehicle in that the filling portion 13 further has a strengthening assist film 16. In FIG. 8, the strengthening assist film 16 is adjacent to a part of the second main surface 11b, a part of the inside end surface 12i of the intermediate film 12, and the surface, facing the second main surface 11b, of the adhesive layer 15. The strengthening assist film 16 is disposed continuously so as to overlap with the entire second region B in a plan view of the first glass plate 11 and to cross the entire boundary between the first region A and the second region B. Furthermore, in the second region B, the first glass plate 11, the strengthening assist film 16, the adhesive layer 15, and the electromagnetic wave transmission member 14 are stacked in this order.

The strengthening assist film 16 has a higher breaking strength than those of the intermediate film 12 and the electromagnetic wave transmission member 14 and thus, it can absorb an impact of an external force transmitted from the first main surface 11a or the electromagnetic wave transmission member 14 without being teared.

For example, a polyester is used preferably as a material of the strengthening assist film 16. Examples of the polyester include polyethylene terephthalate, polypropylene terephthalate, polybutylene terephthalate, and polyethylene naphthalate, and blends of these polymers.

The breaking strength, as measured in accordance with JIS A5759, of the strengthening assist film 16 should be 200 N/25 mm or higher, 250 N/25 mm or higher, or 300 N/25 mm or higher.

Furthermore, for example, in the penetration resistance test, dislocation at the boundary between the inside end surface 17i of the second glass plate 17 and the electromagnetic wave transmission member 14 and dislocation at the boundary between the inside end surface 12i of the intermediate film 12 and the strengthening assist film 16 located between the second main surface 11b and the third main surface 17c can be prevented from coupling with each other. As a result, in the laminated glass 10e for vehicle, strength reduction at the boundary between the first region A and the second region B can be suppressed.

The adhesive layer 15 may be adjacent to the entire surface of the strengthening assist film 16. The strengthening assist film 16 may be the same in thickness as the intermediate film 12. In these cases, since the thickness of the intermediate film 12 in the first region A is approximately the same as that of the filling portion 13 (in the first region A), it is not necessary to laying plural intermediate films or scrape away a part of an intermediate film. In addition, laminating of the glass plates and the intermediate film 12 and charging to the filling portion 13 can be performed easily and fine positioning is not necessary, which are preferable. The expression “approximately the same in thickness” means that a thickness difference of 15% or less is allowable.

The thickness of the strengthening assist film 16 may be 0.05 mm or larger and 1 mm or smaller. In the case where its thickness is 0.05 mm or larger, the shape of the strengthening assist film 16 can be maintained. In the case where its thickness is 0.1 mm or larger, strength reduction can be suppressed effectively. In the case where its thickness is 1 mm or smaller, the electromagnetic wave transmission loss caused by the strengthening assist film 16 can be suppressed. The thickness is preferably 0.8 mm or smaller and even preferably 0.4 mm or smaller.

Next, a distance d16 is defined as the distance that connects an arbitrary point on the boundary between the first region A and the second region B and an arbitrary point on the circumference of the strengthening assist film 16 in the first region A in a plan view of the first glass plate 11. In the case where the distance d16 is short, when an external force acts on the first main surface 11a, the electromagnetic wave transmission member 14 may disengage from the laminated glass 10e for vehicle to cause penetration of a steel ball.

In order to prevent disengagement of the electromagnetic wave transmission member 14 and suppress strength reduction at the boundary between the different materials, the distance d16 is preferably 0.1 mm or longer, even preferably 1 mm or longer, and further preferably 5 mm or longer. The distance d16 is preferably 30 mm or shorter because in that case the boundary between the inside end surface 12i of the intermediate film 12 and the strengthening assist film 16 can be hidden easily by a light shield portion (described later). The distance d16 is even preferably 15 mm or shorter.

### Second Embodiment

A laminated glass for vehicle (laminated glass 20 for vehicle) according to a second embodiment of the present invention will be described below in detail with reference to FIG. 9. In particular, features of the laminated glass 20 for vehicle that are different from the laminated glass 10d for vehicle according to the fourth modification of the first embodiment will be described, and for the other features, corresponding descriptions made for the laminated glass 10d for vehicle according to the fourth modification of the first embodiment will be employed.

The laminated glass 20 for vehicle has a feature that a filling portion 23 exists only in the second region B. The filling portion 23 existing only in the second region B is preferable because it facilitates charging of the filling portion 23 and makes fine positioning unnecessary.

In the laminated glass 20 for vehicle, a first glass plate 21, an intermediate film 22, an adhesive layer 25, and the electromagnetic wave transmission member 24 are stacked in this order in the second region B. The electromagnetic wave transmission member 24 may be side by side with at least a part of an inside end surface 27i of a second glass plate 27. The thickness of the intermediate film 22 may be approximately the same in the first region A and in the second region B. In this case, in the laminated glass 20 for vehicle, it is not necessary to laying plural intermediate films or scrape away a part of an intermediate film to form a step in the thickness direction intentionally.

In the laminated glass 20 for vehicle, since the intermediate film 22 and the electromagnetic wave transmission member 24 have no boundary in the first region A, no dislocation occurs at such a boundary. Furthermore, the intermediate film 22 can absorb an impact irrespective of the position of the first main surface 21a, at which an external force is applied. As a result, strength reduction at the boundary between the first region A and the second region B can be suppressed.

In the laminated glass 20 for vehicle, the adhesive layer 25 bonds the intermediate film 22 and the electromagnetic wave transmission member 24 to each other strongly. Thus, when an external force acts on the first main surface 21a, an event that the electromagnetic wave transmission member 24 disengages to cause penetration of a steel ball can be prevented even though the electromagnetic wave transmission member 24 does not cross the boundary between the first region A and the second region B in a plan view of the first glass plate 21. In particular, this embodiment is highly effective in such a case where the adhesion of the electromagnetic wave transmission member 24 is weak or a case where the electromagnetic wave transmission member 24 exhibits no adhesion.

### Third Embodiment

A laminated glass for vehicle (laminated glass 30 for vehicle) according to a third embodiment of the present invention will be described below in detail with reference to FIG. 10. In particular, features of the laminated glass 30 for vehicle that are different from the laminated glass 10 for vehicle according to the first embodiment will be described, and for the other features, corresponding descriptions made for the laminated glass 10 for vehicle according to the first embodiment will be employed.

The laminated glass 30 for vehicle is different from the first embodiment in that a filling portion 33 exists only in the second region B (i.e., no part of it exists in the first region A).

The thickness (t) of the filling portion 33 at at least a part of the boundary between the first region A and the second region B may be different from a thickness (t_{c}) at the geometrical center of the second region B. The term “geometrical center of the second region B” means the center of gravity of the second region B when the second region B is regarded as a plane figure in a plan view of the first glass plate 31 in which volume and mass are not taken into consideration.

For example, necessary electromagnetic wave transmissivity and suppression of strength reduction at the boundary can both be attained more easily in the case where the filling portion 33 satisfies t>t_{c} at at least a part of the boundary between the first region A and the second region B. Strength reduction at the boundary can be suppressed more in the case where the filling portion 33 satisfies t>t_{c} at the entire boundary between the first region A and the second region B. In this case, it is preferable that the thickness of the filling portion 33 decrease gently from the boundary between the first region A and the second region B toward the geometrical center of the second region B because in that case increase of the haze ratio and distortion can be prevented.

In the laminated glass 30 for vehicle, in particular, the electromagnetic wave transmission member 34 contains a material capable of directly joining it to a second main surface 31b of the first glass plate 31 by heating or pressing, and is adjacent to the second main surface 31b, an inside end surface 32i of an intermediate film 32, and an inside end surface 37i of a second glass plate 37. Since the electromagnetic wave transmission member 34 is adjacent to the second main surface 31b in the second region B, the transmission loss of electromagnetic waves at the interface and the haze ratio can be made smaller than in a configuration in which a part of the intermediate film 32 is located in the second region B.

Examples of materials of the electromagnetic wave transmission member 34 that can be joined directly to the first glass plate 31 by heating or pressing, include urethane resins. A case where a urethane resin in a layer form is used as the electromagnetic wave transmission member 34 will be described below.

As long as the electromagnetic wave transmission member 34 is adjacent to the second main surface 31b, the inside end surface 32i of the intermediate film 32, and the inside end surface 37i of the second glass plate 37, neither the filling portion 33 nor the intermediate film 32 needs to be disposed continuously so as to cross the entire boundary between the first region A and the second region B in a plan view of the first glass plate 31.

In manufacturing the laminated glass 30 for vehicle according to this embodiment, joining of the electromagnetic wave transmission member 34 to the first glass plate 31 and joining of the second glass plate 37 to the first glass plate 31 via the intermediate film 32 can be performed simultaneously by one heating and pressing process. Furthermore, since both of the urethane resin and the intermediate film are adhesive to each other, the electromagnetic wave transmission member 34 and the inside end surface 32i of the intermediate film 32 can be bonded to each other strongly. Thus, strength reduction at the boundary between the first region A and the second region B can be suppressed.

Although the urethane resin may be of a single layer, in order to increase the strength, it is preferable that plural layers be stacked and used as the electromagnetic wave transmission member 34. In the case where the urethane resin is used as the electromagnetic wave transmission member 34, the number of the urethane resin layers may be in a range of 1 to 5 from the viewpoints of strength and electromagnetic wave transmissivity. In particular, since the adhesion and the joining strength between first glass plate 31 and the urethane resin are increased by using plural urethane resin layers, the number of urethane resin layers is preferably in a range of 2 to 5, even preferably in a range of 2 to 4, and further preferably 2.

The thickness of the urethane resin may be such that the urethane resin is adjacent to at least a part of the inside end surface 37i of the second glass plate 37 in the entire boundary between the first region A and the second region B. More specifically, from the viewpoint of strength, the ratio of the thickness of the part of the urethane resin layer that is adjacent to the inside end surface 37i of the second glass plate 37 to the thickness of the inside end surface 37i of the second glass plate 37 is preferably 0.3 or larger, even preferably 0.5 or larger, and further preferably 0.6 or larger. From the viewpoint of millimeter-wave transmissivity, the ratio is preferably 1 or smaller, even preferably 0.95 or smaller, and further preferably 0.9 or smaller.

From the viewpoint of strength, the tear strength of the urethane resin layer as measured by the test method prescribed in the ASTM Standard D624, Die C is preferably 40 kN/m or higher and even preferably 50 kN/m or higher. From the viewpoint of strength, the tensile strength as measured by the test method prescribed in the ASTM Standard D412 is preferably 30 MPa or higher and even preferably 40 MPa or higher.

The ratio at which a signal is scattered without being transmitted can be made smaller as the haze ratio in the second region B of the laminated glass 30 for vehicle measured by the test method prescribed in the ASTM Standard D1003 is smaller. More specifically, the haze ratio is preferably 5% or smaller because in that case a good field of view can be secured. The haze ratio is even preferably 1% or smaller because in that case an information device (described later) can transmit and receive a signal accurately. The haze ratio is further preferably 0.6% or smaller because in that case the signal transmission and reception can be made more accurate.

### Fourth Embodiment

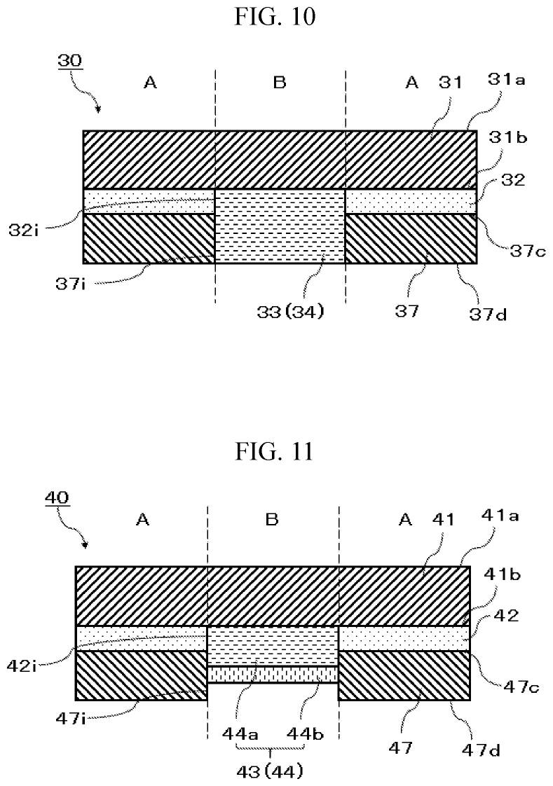

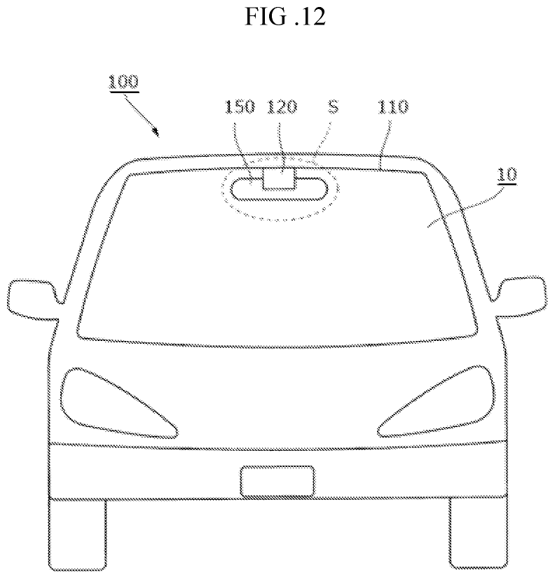

A laminated glass for vehicle (laminated glass 40 for vehicle) according to a fourth embodiment of the present invention will be described below in detail with reference to FIG. 11. In particular, for the laminated glass 40 for vehicle according to the fourth embodiment, features that are different from the laminated glass 30 for vehicle according to the third embodiment will be described, and for the other features, corresponding descriptions made for the laminated glass 30 for vehicle according to the third embodiment will be employed.

The laminated glass 40 for vehicle illustrated in FIG. 11 is different in that an electromagnetic wave transmission member 44 further has a resin layer 44b that is different from a urethane resin layer 44a on the surface, opposite to a second main surface 41b, of the urethane resin layer 44a. The urethane resin layer 44a is the same as or similar to the urethane resin in a layer form that can be used as the electromagnetic wave transmission member 34 of the laminated glass 30 for vehicle illustrated in FIG. 10.

An electromagnetic wave transmission member that is different from the urethane resin layer 44a is used as the resin layer 44b. In the case where the resin layer 44b is formed by using a material that is harder than urethane resin, the urethane resin layer can be made not prone to be scratched. This makes it possible to prevent reduction of transmittance due to scattering of a signal. Examples of the materials of the resin layer 44b include polycarbonate resins, cycloolefin polymers (COP) and the like although the material of the resin layer 44b is not limited to them. The resin layer 44b is not limited to the case of a single layer and it may be formed by plural layers.

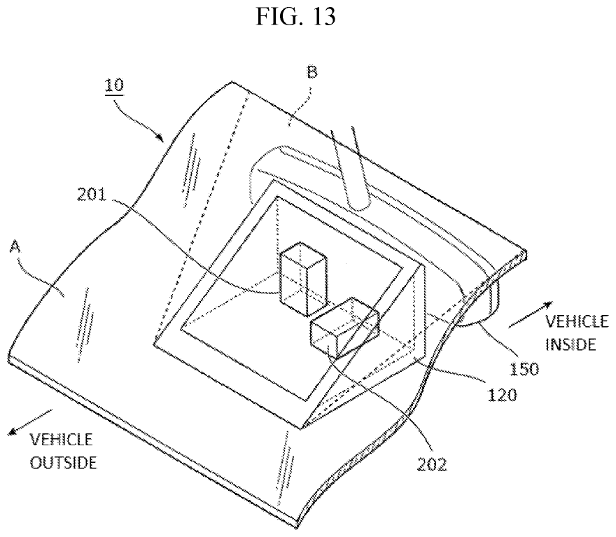

The case where the laminated glass 10 for vehicle according to the first embodiment, for example, is installed in an automobile as a laminated glass for vehicle according to the present invention will be described below with reference to FIG. 12 and FIG. 13.

FIG. 12 is a conceptual diagram illustrating a state that the laminated glass 10 for vehicle is attached to a front opening portion 110 formed on an automobile 100. A housing (case) 120 in which an information device for securing safety of driving of the vehicle is housed is attached to the fourth main surface 17d of the laminated glass 10 for vehicle.

The information device is a device for preventing rear-end collision or crashing with a front vehicle, a pedestrian, an obstacle, and the like existing in front of the vehicle concerned and/or notifying the driver of danger by using a camera, a radar, or the like. For example, the information device is an information receiving device and/or an information transmitting device or the like, and includes a millimeter-wave radar, a stereo camera, an infrared laser, and the like; as such, the information device transmits and receives a signal. The term “signal” means electromagnetic waves including millimeter waves, visible light, infrared light, and the like.

FIG. 13 is an enlarged view of a portion S illustrated in FIG. 12 and is a perspective view illustrating a portion in which the housing 120 is attached to the laminated glass 10 for vehicle. For example, a millimeter-wave radar 201 and a stereo camera 202 are housed in the housing 120 as the information device. As illustrated in FIG. 13, the laminated glass 10 for vehicle is used in such a manner that the second region B which is a region superior in electromagnetic wave transmissivity is located around the information device such as the millimeter-wave radar 201 and the stereo camera 202.

Although the housing 120 which houses the information device is usually installed outside a rearview mirror 150 in the vehicle, it may be attached to another portion. In the case of a windshield, the housing 120 may be attached to a test region B, a region other than a region obtained by expanding the test region B in the horizontal direction of the windshield, a test region I or a region other than a region obtained by expanding the test region I in the horizontal direction of the windshield. In the case of a rear glass, the housing 120 may be attached to, for example, a portion located below a high mount stop lamp.

In the case where a communication is performed with the outside by using a millimeter-wave radar or the like installed inside an automobile, the angle at which electromagnetic waves are incident on a window glass surface such as the windshield surface varies depending on the structure of the window glass, the position of a communication counterpart, the elevation angle of the millimeter-wave radar with respect to a running direction, and other factors.

However, in view of the inclination angle of the windshield with respect to the horizontal plane in common automobiles, about 67.5° is employed as a rough standard angle at which electromagnetic waves from a millimeter-wave radar are incident on the windshield surface. That is, the electromagnetic wave transmittance T(F) of millimeter waves that are incident on the surface of a window glass of an automobile at an incident angle of 67.5° is an important index of millimeter-wave transmittance of the window glass for vehicle. Incident angles in the vicinity of 67.5° are also useful in evaluating millimeter-wave transmittance.

For the laminated glass 10 for vehicle according to this embodiment of the present invention, it is preferable that the transmittance T(F) of electromagnetic waves having a frequency F (GHz) that are incident at the incident angle of 67.5° on the first main surface 11a in the second region B satisfy the following Expression (1) in a range of 60 GHz F 100 GHz because it exhibits high transmittance also for electromagnetic waves in a frequency band of several tens of gigahertz to 100 GHz. The transmittance is equal to 100% when T(F) has a value “1.”

T(F)>−0.0061×F+0.9384 (1)

In order to obtain even more excellent electromagnetic wave transmissivity, for the laminated glass 10 for vehicle according to this embodiment of the present invention, it is preferable that the transmittance T(F) of electromagnetic waves having a frequency F (GHz) that are incident at the incident angle of 67.5° on the first main surface 11a in the second region B satisfy the following Expression (2) in a range 60 GHz≤F≤100 GHz.

T(F)>−0.0061×F+1.0384 (2)

In the laminated glasses 10-40 for vehicle according to the present invention, the first glass plate, the electromagnetic wave transmission member, the second glass plate, the intermediate film, the adhesive layer, the strengthening assist film, or the like may be provided with a functional layer as long as it does not impair the advantages of the present invention. For example, they may be provided with a coating layer that imparts a water repellency function, a hydrophilic function, an anti-fogging function or the like, or an infrared reflection film. The filling portions 13-43 may be constituted to include a member other than the respective electromagnetic wave transmission members 14-44.

Examples of the other member include adhesives, paints, glass, conductors, light-emitting bodies, ultraviolet absorbers, and the like. The filling portions 13-43 may include another member in such a range that the laminated glasses 10-40 for vehicle at least satisfy the prescribed impact resistance and penetration resistance of the above-mentioned falling ball tests and, furthermore, the electromagnetic wave transmissivity is not impaired.

There are no particular limitations on the position of the functional layer provided; it may be provided on the surface of each of the laminated glasses 10-40 for vehicle or provided so as to be interposed between plural intermediate films. Furthermore, each of the laminated glasses 10-40 for vehicle according to the present invention may be provided with a light shield portion that is partially or entirely disposed in a zonal manner in a circumferential portion to hide a boundary portion between different materials, a portion for attachment to a frame body or the like, wiring conductors, or the like.

For example, as the light shield portion, the first glass plate or the second glass plate may be provided with a black ceramic layer or the like and the intermediate film may be provided with a colored portion. The black ceramic layer can be formed on the second main surface and/or the fourth main surface. In the case where the black ceramic layer is formed on the second main surface, high hiding performance can be attained when viewed from outside the vehicle. In the case where the black ceramic layer is formed on the fourth main surface, high hiding performance can be attained when viewed from inside the vehicle. The colored portion is not limited to a black one; various colors may be used as long as it can interrupt visible light to such an extent as to be able to hide at least a portion to be hidden.

Although the laminated glasses 10-40 for vehicle according to the present invention have been described above for the case where they are used as, for example, the windshield of a vehicle, they can also be used as a rear glass or a side glass.

### EXAMPLES

Although the present invention will be described below in a specific manner with reference to Examples, the present invention is not limited to them.

### Inventive Example 1

A glass (300 mm×300 mm, thickness: 2 mm) consisting of, in mol % in terms of the oxide of each component, SiO₂ at 69.7%, Al₂O₃ at 0.9%, MgO at 7%, CaO at 9%, TiO₂ at 0.05%, Na₂O at 12.6%, K₂O at 0.6%, and Fe₂O₃ at 0.2% was used as each of the first glass plate and the second glass plate. Films made of polyvinyl butyral (PVB) (produced by Sekisui Chemical Co., Ltd., 300 mm×300 mm, thickness: 0.76 mm or 0.38 mm) were used as the intermediate films. A film made of polyethylene terephthalate (PET) (220 mm×220 mm, thickness: 0.15 mm) was used as the electromagnetic wave transmission member. An opening portion measuring 200 mm×200 mm was formed through the second glass plate and the 0.38 mm-thick intermediate film so that the distance between an end portion of the first glass plate and the second region B became 50 mm. The first glass plate, the 0.76 mm-thick intermediate film, the electromagnetic wave transmission member, the 0.38 mm-thick intermediate film, and the second glass plate were stacked in this order so that d13 (d14) became 10 mm, they were set in a vacuum environment by using a vacuum packing machine, and then they were pressure-bonded to each other tentatively by heating (120° C., 30 minutes).

The resultant was further subjected to pressure-bonding treatment (1 MPa, 130° C., 90 minutes) by using an autoclave, whereby a laminated glass for vehicle of Inventive Example 1 which had the configuration of the third modification of the first embodiment illustrated in FIG. 6 was obtained.

### Inventive Example 2

The same first glass plate, second glass plate, and intermediate film as used in Inventive Example 1 were used except that only a single intermediate film (thickness: 0.76 mm) was used. A resin plate made of polycarbonate (PC) (produced by Zeon Corporation, 200 mm×200 mm, thickness: 2 mm, linear expansion coefficient at 100° C.: 70×10⁻⁶° C.⁻¹) was used as the electromagnetic wave transmission member. An adhesive layer was formed by applying a transparent pressure-sensitive adhesive (produced by Taica Corporation) so as to have a thickness of 0.5 mm to one main surface of the electromagnetic wave transmission member by a roll process. Then the first glass plate, the intermediate film, and the second glass plate were stacked in this order and the electromagnetic wave transmission member with the adhesive layer was laminated in the opening portion of the second glass plate as in the second embodiment illustrated in FIG. 9. The resultant was pressure-bonded to each other tentatively by using the vacuum packing machine under the same conditions as in Inventive Example 1 and then subjected to pressure-bonding treatment by using the autoclave, whereby a laminated glass for vehicle of Inventive Example 2 was obtained.

### Inventive Example 3

The same first glass plate, second glass plate, and intermediate film as used in Inventive Example 1 were used except that only a single intermediate film (thickness: 0.76 mm) was used and its central portion was cut away to coextend with the opening portion of the second glass plate. A two-layer resin plate made of urethane (200 mm×200 mm, thickness: 1.27 mm, linear expansion coefficient at 100° C.: 10×10⁻⁵° C.⁻¹) was used as the electromagnetic wave transmission member. After the first glass plate, the intermediate film, the second glass plate, and the two-layer urethane resin plate were stacked as in the third embodiment illustrated in FIG. 10, the resultant was pressure-bonded to each other tentatively by using the vacuum packing machine under the same conditions as in Inventive Example 1 and then subjected to pressure-bonding treatment by using the autoclave, whereby a laminated glass for vehicle of Inventive Example 3 was obtained. In the thus-obtained laminated glass for vehicle of Inventive Example 3, t was about 2.5 mm and t>t_{c} was satisfied at the entire boundary between the first region A and the second region B. The ratio of the thickness of a portion, being adjacent to the inside end surface 37i of the second glass plate 37, of the urethane resin with respect to the thickness of the inside end surface 37i of the second glass plate 37 was about 0.87.

### Inventive Example 4

The same first glass plate, second glass plate, and intermediate film as used in Inventive Example 3 were used. As for the electromagnetic wave transmission member, the same two-layer urethane resin plate as used in Inventive Example 3 was used as a urethane resin, and a polycarbonate (PC) resin plate (produced by Zeon Corporation, 200 mm×200 mm, thickness: 2 mm, linear expansion coefficient at 100° C.: 70×10⁻⁶° C.⁻¹) was used as a resin layer. After the first glass plate, the intermediate film, the second glass plate, the urethane resin layer, and the resin layer (PC) were stacked as in the fourth embodiment illustrated in FIG. 11, the resultant was pressure-bonded to each other tentatively by using the vacuum packing machine under the same conditions as in Inventive Example 1 and then subjected to pressure-bonding treatment by using the autoclave, whereby a laminated glass for vehicle of Inventive Example 4 was obtained.

### Comparative Example 1

A laminated glass for vehicle of Comparative Example 1 was obtained by using the same members and process as in Inventive Example 2, except that no pressure-sensitive transparent adhesive was used and no adhesive layer was provided.

### Comparative Example 2

A glass (300 mm×300 mm, thickness: 2 mm) that was used conventionally as a laminated glass for vehicle was used as each of the first glass plate and the second glass plate, and a film made of polyvinyl butyral (PVB) (produced by Sekisui Chemical Co., Ltd., 300 mm×300 mm, thickness: 0.76 mm) was used as the intermediate film. Neither opening portion nor cut portion was formed in the second glass plate and the intermediate film. The first glass plate, the intermediate film, and the second glass plate were stacked in this order, and the resultant was pressure-bonded to each other tentatively by using the vacuum packing machine under the same conditions as in Inventive Example 1 and then subjected to pressure-bonding treatment by using the autoclave, whereby a laminated glass for vehicle of Comparative Example 2 was obtained.

### Measurement of Haze Ratio:

The haze ratio is obtained as a percentage of transmission light that is deviated by 2.5° or more from incident light by forward scattering with respect to transmission light that is transmitted through a measurement target laminated glass in its thickness direction. In the present invention, the haze ratio was determined by using a commercially available haze meter in accordance with the test method prescribed in the ASTM Standard D1003. The results are shown in Table 1.

### Falling Ball Tests:

The laminated glass for vehicle of each of Inventive Examples 1-4 and Comparative Examples 1 and 2 was subjected to the impact resistance test and the penetration resistance prescribed in the JIS Standard R3212: 2015 (Test methods of safety glazing materials for road vehicles) and whether they satisfy the prescribed impact resistance and penetration resistance that are prescribed in the JIS Standard R3211: 2015 (Safety glazing materials for road vehicles) was checked. The case that satisfied the prescribed impact resistance or penetration resistance is marked “A” and the case that did not satisfy the prescribed impact resistance or penetration resistance is marked “B” in Table 1. Inventive Examples 1-4 and Comparative Example 2 satisfied the prescribed impact resistance and penetration resistance, and Comparative Example 1 satisfied neither or them.

### Measurement of Electromagnetic Wave Transmittance T(F):

The transmittance T(F) at the frequency F (GHz) of electromagnetic waves incident at an incident angle of 67.5° on the laminated glass for vehicle of each of Inventive Examples 1-4 and Comparative Examples 1 and 2 was calculated by a simulation in a range of 60 GHz≤F (GHz)≤100 GHz. In the simulation, in each of Inventive Examples 1-4 and Comparative Examples 1 and 2, an insertion loss (S21 parameter) calculated on the basis of a permittivity and a dielectric loss tangent of each material used was converted into a (millimeter-wave) transmittance. For the laminated glasses of Inventive Example 3 and Comparative Example 2, an electromagnetic wave transmissivity of the manufactured laminated glass was measured by a free space method. As for the electromagnetic wave transmissivity, antennas were placed opposed to each other and the manufactured laminated glass was placed at the middle between antennas so that the incident angle became 67.5°, and an electromagnetic wave transmittance was calculated on the basis of a measurement result of an electromagnetic wave transmission loss obtained for electromagnetic waves having a frequency of 79 GHz at an opening portion of a diameter 100 mm when a value of the case having no electromagnetic wave transmissive substrate was regarded as 0 dB. As a result, the electromagnetic wave transmittance at 79 GHz of the laminated glass of each of Inventive Example 3 and Comparative Example 2 was equivalent to a simulation result.

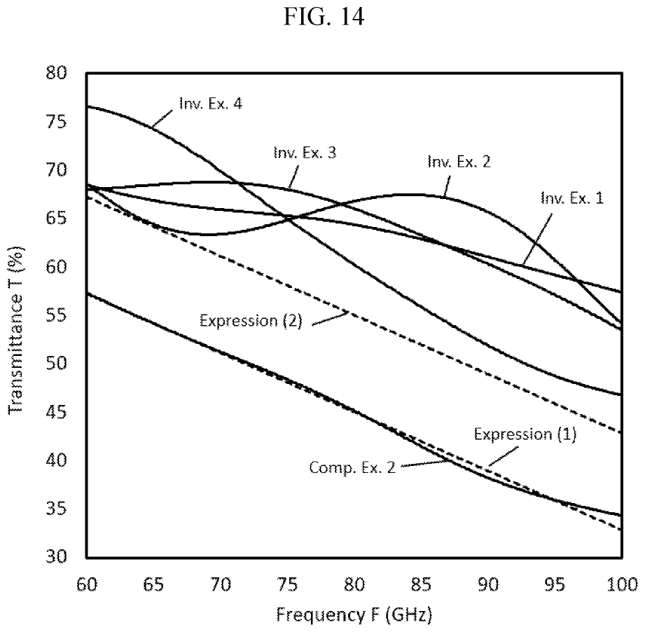

Simulation results of Inventive Examples 1-4 and Comparative Example 2 are shown in FIG. 14. Broken-line curves in FIG. 14 represent the following Expressions (1) and (2).

T(F)>−0.0061×F+0.9384 (1)

T(F)>−0.0061×F+1.0384 (2)

The simulation result of Comparative Example 1 is not shown, but it was approximately the same as that of Inventive Example 2 and satisfied the above-described Expression (1) in the range of 60 GHz≤F (GHz)≤100 GHz.

The laminated glass of Comparative Example 2 in which the transmittance T(F) at the frequency F (GHz) of electromagnetic waves incident at 67.5° did not satisfy Expression (1) at certain frequencies in the range of 60 GHz≤F (GHz)≤100 GHz was inferior in electromagnetic wave transmissivity. In Table 1, occurrence of frequencies at which Expression (1) or (2) was not satisfied is indicated by mark “B.” On the other hand, the laminated glasses of Inventive Examples 1-4 in which the transmittance T(F) at the frequency F (GHz) of electromagnetic waves incident at 67.5° satisfies Expression (1) and (2) in the range of 60 GHz≤F (GHz)≤100 GHz was superior in electromagnetic wave transmissivity. Satisfaction of Expression (1) and (2) in the entire range of 60 GHz≤F (GHz)≤100 GHz is indicated by mark “A.”

### Evaluation of Electromagnetic Wave Transmissivity:

Using the above-mentioned measurement results of electromagnetic wave transmissivity, a laminated glass was evaluated as being defective (B) if its electromagnetic wave transmission loss at a frequency of 79 GHz was larger than 3 dB and good (A) if it was 3 dB or smaller. The evaluation results are shown in Table 1.

TABLE 1

| | | | | | | | | Electromagnetic wave | | |
|---|---|---|---|---|---|---|---|---|---|---|
| | | | | | | | | transmissivity | | |
| | | | | | | | | | | Electro- |
| | | Electromagnetic wave | | | | Falling ball tests | | | | magnetic |
| | Corresponding | transmission member | | Adhesive | | Impact | Penetration | Expression | Expression | waves at |
| | figure | Material | Thickness | layer | Haze | resistance | resistance | (1) | (2) | 79 GHz |
| Inv. | FIG. 6 | PET | 0.15 mm | None | 0.6% | A | A | A | A | A |
| Ex. 1 | | | | | | | | | | |
| Inv. | FIG. 9 | PC | 2 mm | 0.5 mm | <0.5% | A | A | A | A | A |
| Ex. 2 | | | | | | | | | | |
| Inv. | FIG. 10 | Urethane | 1.27 mm | None | 0.6-0.8% | A | A | A | A | A |
| Ex. 3 | | resin | | | | | | | | |
| Inv. | FIG. 11 | Urethane | 1.27 mm/ | None | 0.6-0.8% | A | A | A | A | A |
| Ex. 4 | | resin/PC | 0.5 mm | | | | | | | |
| Comp. | None | PC | 2 mm | None | 5.7% | B | B | A | A | A |
| Ex. 1 | | | | | | | | | | |
| Comp. | None | None | None | None | 0.3% | A | A | B | B | B |
| Ex. 2 | | | | | | | | | | |

Inventive Examples 1-4 satisfy the configurations of the first to fourth embodiments of the present invention, respectively, and hence were high in both of electromagnetic wave transmissivity and strength.

On the other hand, Comparative Example 1 in which no adhesive layer was provided and the configuration of the second embodiment of the present invention was not satisfied was therefore inferior in strength.

Comparative Example 2 in which no electromagnetic wave transmission member was provided and the configuration of any embodiment of the present invention was not satisfied was therefore inferior in electromagnetic wave transmissivity.

Although the various embodiments have been described above with reference to the drawings, it goes without saying that the present invention is not limited to these examples. It is apparent that those skilled in the art could conceive various changes and modifications within the confines of the claims, and they are construed as being included in the technical scope of the present invention. Constituent elements of the above-described embodiments may be combined in a desired manner without departing from the spirit and scope of the present invention.

The present application is based on Japanese Patent Application No. 2019-230102 filed on Dec. 20, 2019, the disclosure of which is incorporated herein by reference.

### REFERENCE SYMBOL LIST

10, 10a, 10b, 10c, 10d, 10e, 20, 30, 40: Laminated glass for vehicle
11, 21, 31, 41: First glass plate
11a, 21a, 31a, 41a: First main surface
11b, 21b, 31b, 41b: Second main surface
12, 22, 32, 42: Intermediate film
12i, 32i, 42i: Inside end surface of intermediate film 12, 32, or 42
13, 23, 33, 43: Filling portion
14, 24, 34, 44: Electromagnetic wave transmission member
44a: Urethane resin layer
44b: Resin layer
15, 25: Adhesive layer
16: Strengthening assist film
17, 27, 37, 47: Second glass plate
17i, 27i, 37i, 47i: Inside end surface of second glass plate 17, 27, 37, or 47
17c, 27c, 37c, 47c: Third main surface
17d, 27d, 37d, 47d: Fourth main surface
18x: Opening portion
18y: Cut portion
100: Automobile
110: Opening portion
120: Housing
150: Rearview mirror
201: Millimeter-wave radar
202: Stereo camera
A: First region
B: Second region

What is claimed is:

1. A laminated glass for vehicle, comprising a first glass plate and a second glass plate joined to each other by an intermediate film, wherein
the first glass plate has a first main surface and a second main surface;
the second glass plate has a third main surface and a fourth main surface;
the second main surface and the third main surface face the intermediate film;
the laminated glass for vehicle has a first region A that is provided with the second glass plate and a second region B that is not provided with the second glass plate in a plan view of the first glass plate;
the laminated glass for vehicle comprises a filling portion that is disposed continuously from the second main surface on the second region B toward a space between the first glass plate and the second glass plate in the first region A to cross the entire boundary between the first region A and the second region B;
the filling portion comprises a electromagnetic wave transmission member; and
the second region B is higher in transmittance of millimeter waves than the first region A.

2. The laminated glass for vehicle according to claim 1, having a distance of 0.1 mm or longer between the boundary between the first region A and the second region B and a circumference of the filling portion in the first region A in the plan view of the first glass plate.

3. The laminated glass for vehicle according to claim 1, having a distance of 1 mm or longer between the boundary between the first region A and the second region B and a circumference of the filling portion in the first region A in the plan view of the first glass plate.

4. The laminated glass for vehicle according to claim 1, wherein
the filling portion comprises an adhesive layer, and
the adhesive layer is adjacent to at least a part of a surface, facing the second main surface, of the electromagnetic wave transmission member.

5. The laminated glass for vehicle according to claim 4, wherein the adhesive layer is adjacent to at least a part of the second main surface.

6. The laminated glass for vehicle according to claim 4, wherein
the filling portion further comprises a strengthening assist film,
the strengthening assist film is disposed continuously so as to overlap with the entire second region B in the plan view of the first glass plate and to cross the entire boundary between the first region A and the second B region, and
in the second region B, the first glass plate, the strengthening assist film, the adhesive layer, and the electromagnetic wave transmission member are stacked in this order.

7. The laminated glass for vehicle according to claim 4, wherein the adhesive layer has a storage shearing modulus being in a range of 5×10² Pa to 1×10⁷ Pa at 25° C. and a frequency of 1 Hz.

8. The laminated glass for vehicle according to claim 1, wherein the electromagnetic wave transmission member comprises an alkali-free glass or a resin.

9. The laminated glass for vehicle according to claim 1, wherein a transmittance T(F) of electromagnetic waves having a frequency F (GHz) that are incident at an incident angle of 67.5° on the first main surface in the second region satisfies the following Expression (1) in a range of 60 GHz≤F≤100 GHz:
T(F)>−0.0061×F+0.9384 (1).

10. A laminated glass for vehicle, comprising a first glass plate and a second glass plate joined to each other by an intermediate film, wherein
the first glass plate has a first main surface and a second main surface;
the second glass plate has a third main surface and a fourth main surface;
the second main surface and the third main surface face the intermediate film;
the laminated glass for vehicle has a first region A that is provided with the second glass plate and a second region B that is not provided with the second glass plate in a plan view of the first glass plate;
the intermediate film is disposed continuously so as to overlap with the entire second region B in the plan view of the first glass plate and to cross the entire boundary between the first region A and the second region B;
the laminated glass for vehicle comprises a filling portion only above the second main surface in the second region B;
the filling portion comprises an electromagnetic wave transmission member and an adhesive layer that is disposed on a surface, facing the second main surface, of the electromagnetic wave transmission member;
in the second region B, the first glass plate, the intermediate film, the adhesive layer, and the electromagnetic wave transmission member are stacked in this order; and
the second region B is higher in transmittance of millimeter waves than the first region A.

11. The laminated glass for vehicle according to claim 10, wherein the intermediate film has a thickness approximately the same in the first region A and in the second region B.

12. The laminated glass for vehicle according to claim 10, wherein the adhesive layer comprises at least one selected from the group consisting of a photocurable resin composition, a thermosetting resin composition, and a photocurable and thermosetting resin composition.

13. The laminated glass for vehicle according to claim 10, wherein the adhesive layer has a storage shearing modulus being in a range of 5×10² Pa to 1×10⁷ Pa at 25° C. and a frequency of 1 Hz.

14. The laminated glass for vehicle according to claim 10, wherein the electromagnetic wave transmission member comprises an alkali-free glass or a resin.

15. The laminated glass for vehicle according to claim 10, wherein a transmittance T(F) of electromagnetic waves having a frequency F (GHz) that are incident at an incident angle of 67.5° on the first main surface in the second region B satisfies the following Expression (1) in a range of 60 GHz≤F≤100 GHz:
T(F)>−0.0061×F+0.9384 (1).

16. A laminated glass for vehicle, comprising a first glass plate and a second glass plate joined to each other by an intermediate film, wherein
the first glass plate has a first main surface and a second main surface;
the second glass plate has a third main surface and a fourth main surface;
the second main surface and the third main surface face the intermediate film;
the laminated glass for vehicle has a first region A that is provided with the second glass plate and a second region B that is not provided with the second glass plate in a plan view of the first glass plate;
the laminated glass for vehicle comprises a filling portion only on the second main surface in the second region;
the filling portion comprises an electromagnetic wave transmission member;
the electromagnetic wave transmission member is adjacent to the second main surface, an inside end surface of the intermediate film, and an inside end surface of the second glass plate, and comprises at least one layer of a urethane resin layer; and
the second region B is higher in transmittance of millimeter waves than the first region A.

17. The laminated glass for vehicle according to claim 16, wherein the electromagnetic wave transmission member further comprises a resin layer that is different from the urethane resin layer on a surface, opposite to the second main surface, of the urethane resin layer.

18. The laminated glass for vehicle according to claim 16, wherein a ratio of a thickness of a part of the urethane resin layer that is adjacent to the inside end surface of the second glass plate to a thickness of the inside end surface of the second glass plate is 0.3 or larger.

19. The laminated glass for vehicle according to claim 16, wherein the filling portion has a thickness (t) at at least a part of a boundary between the first region A and the second region B and a thickness (t_{c}) at a geometrical center of the second region B, the thickness (t) is larger than the thickness (t_{c}).

20. The laminated glass for vehicle according to claim 16, wherein a transmittance T(F) of electromagnetic waves having a frequency F (GHz) that are incident at an incident angle of 67.5° on the first main surface in the second region B satisfies the following Expression (1) in a range of 60 GHz≤F≤100 GHz:
T(F)>−0.0061×F+0.9384 (1).
